(19) United States
(12) Patent Application Publication
(10) Pub. No.: US 2015/0039208 A1
(43) Pub. Date: Feb. 5, 2015

(54) SYSTEM AND METHOD FOR CONTROLLING AIR FLOW THROUGH AN ENGINE BASED ON A FUEL INJECTION DURATION LIMIT

(71) Applicant: GM Global Technology Operations LLC, Detroit, MI (US)

(72) Inventors: Rafat F. Hattar, Royal Oak, MI (US); Kenneth R. Kridner, Lake Orion, MI (US)

(73) Assignee: GM Global Technology Operations LLC, Detroit, MI (US)

(21) Appl. No.: 13/953,884

(22) Filed: Jul. 30, 2013

(51) Int. Cl. F02D 43/00

(52) U.S. Cl. CPC F02D 43/00
USPC 701/104

(57) ABSTRACT

A system according to the principles of the present disclosure includes a desired injection duration module, a fuel control module, and a throttle control module. The desired injection duration module determines a desired injection duration. The fuel control module compares the desired injection duration to an injection duration limit and controls a fuel injector of an engine based on the injection duration limit when the desired injection duration is greater than the injection duration limit. The throttle control module controls a throttle of the engine based on the injection duration limit when the desired injection duration is greater than the injection duration limit.

### FIELD

The present disclosure relates to internal combustion engines, and more specifically, to systems and methods for controlling air flow to each cylinder of an engine based on a fuel injection duration limit.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. Air flow into the engine is regulated via a throttle. More specifically, the throttle adjusts throttle area, which increases or decreases air flow into the engine. As the throttle area increases, the air flow into the engine increases. A fuel control system adjusts the rate that fuel is injected to provide a desired air/fuel mixture to the cylinders and/or to achieve a desired torque output. Increasing the amount of air and fuel provided to the cylinders increases the torque output of the engine.

In spark-ignition engines, spark initiates combustion of an air/fuel mixture provided to the cylinders. In compression-ignition engines, compression in the cylinders combusts the air/fuel mixture provided to the cylinders. Spark timing and air flow may be the primary mechanisms for adjusting the torque output of spark-ignition engines, while fuel flow may be the primary mechanism for adjusting the torque output of compression-ignition engines.

### SUMMARY

A system according to the principles of the present disclosure includes a desired injection duration module, a fuel control module, and a throttle control module. The desired injection duration module determines a desired injection duration. The fuel control module compares the desired injection duration to an injection duration limit and controls a fuel injector of an engine based on the injection duration limit when the desired injection duration is greater than the injection duration limit. The throttle control module controls a throttle of the engine based on the injection duration limit when the desired injection duration is greater than the injection duration limit.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the principles of the present disclosure;

FIG. 2 is a functional block diagram of an example control system according to the principles of the present disclosure; and

FIG. 3 is a flowchart illustrating an example control method according to the principles of the present disclosure.

In the drawings, reference numbers may be reused to identify similar and/or identical elements.

### DETAILED DESCRIPTION

A system and method may control air flow to each cylinder of an engine based on a limit on the amount of fuel flow through a fuel injector. For example, the system and method may adjust a desired fuel flow to the fuel flow limit when the desired fuel flow is greater than the fuel flow limit, and may control the air flow based on the fuel flow limit and a desired air/fuel ratio. Controlling air flow in this manner requires calibration to develop a relationship between fuel injector control parameters (e.g., start of injection, injection duration, end of injection) and fuel flow through the fuel injector.

A system and method according to the present disclosure controls air flow to each cylinder of an engine based on a limit on the delivery duration of fuel injection. The system and method may adjust a desired delivery duration to the delivery duration limit when the desired delivery duration is greater than the delivery duration limit, and may control the air flow based on delivery duration limit. The delivery duration limit may be determined based on fuel injector characteristics, combustion stability, and particulate emission levels. Controlling air flow in this manner reduces calibration time and complexity, improves the consistency of emission levels, and provides consistent fuel injection behavior and air flow per cylinder limitation.

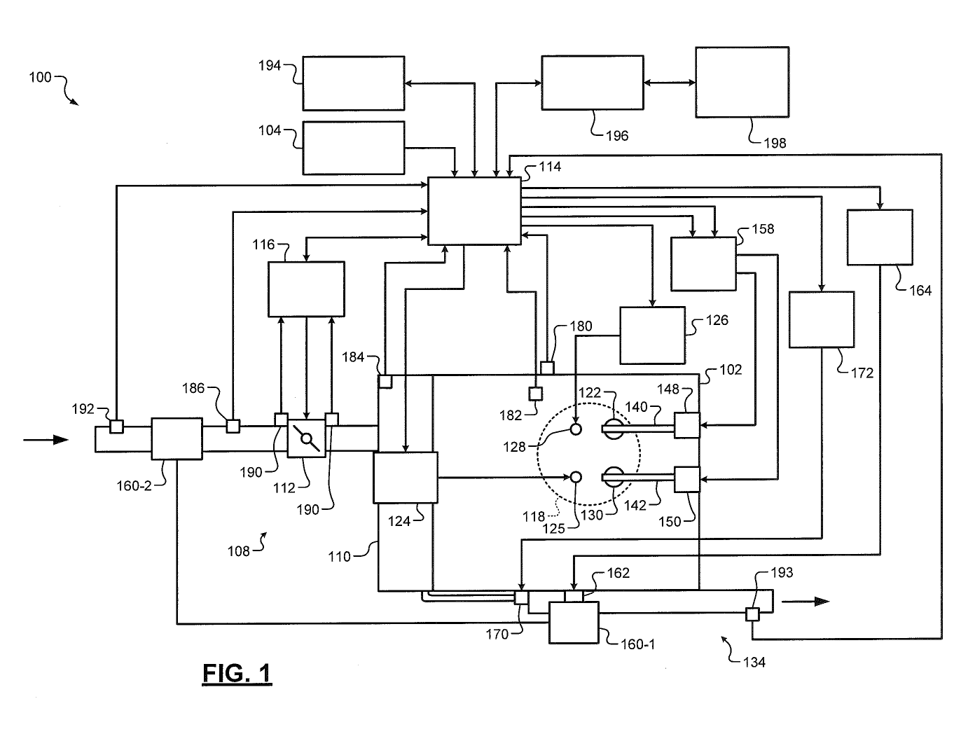

Referring now to FIG. 1, an engine system 100 includes an engine 102 that combusts an air/fuel mixture to produce drive torque for a vehicle. The amount of drive torque produced by the engine 102 is based on a driver input from a driver input module 104. The driver input may be based on a position of an accelerator pedal. The driver input may also be based on a cruise control system, which may be an adaptive cruise control system that varies vehicle speed to maintain a predetermined following distance. The driver input may also be based on an ignition system.

Air is drawn into the engine 102 through an intake system 108. For example only, the intake system 108 may include an intake manifold 110 and a throttle valve 112. For example only, the throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. While the engine 102 may include multiple cylinders, for illustration purposes, a single representative cylinder 118 is shown. For example only, the engine 102 may include 2, 3, 4, 5, 6, 8, 10, and/or 12 cylinders. The ECM 114 may deactivate some of the cylinders, which may improve fuel economy under certain engine operating conditions.

The engine 102 may operate using a four-stroke cycle. The four strokes, described below, are named the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates a fuel injector 125 to achieve a desired air/fuel ratio. The fuel injector 125 may inject fuel directly into the cylinders, as shown, or into mixing chambers associated with the cylinders. In various implementations, fuel may be injected into the intake manifold 110 at a central location or at multiple locations, such as near the intake valve 122 of each of the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression in the cylinder 118 ignites the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. The timing of the spark may be specified relative to the time when the piston is at its topmost position, referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with crankshaft angle. In various implementations, the spark actuator module 126 may halt provision of spark to deactivated cylinders.

Generating the spark may be referred to as a firing event. The spark actuator module 126 may have the ability to vary the timing of the spark for each firing event. The spark actuator module 126 may even be capable of varying the spark timing for a next firing event when the spark timing signal is changed between a last firing event and the next firing event. In various implementations, the engine 102 may include multiple cylinders and the spark actuator module 126 may vary the spark timing relative to TDC by the same amount for all cylinders in the engine 102.

During the combustion stroke, the combustion of the air/fuel mixture drives the piston down, thereby driving the crankshaft. The combustion stroke may be defined as the time between the piston reaching TDC and the time at which the piston returns to bottom dead center (BDC). During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The time at which the intake valve 122 is opened may be varied with respect to piston TDC by an intake cam phaser 148. The time at which the exhaust valve 130 is opened may be varied with respect to piston TDC by an exhaust cam phaser 150. A valve actuator module 158 may control the intake and exhaust cam phasers 148, 150 based on signals from the ECM 114. When implemented, variable valve lift may also be controlled by the valve actuator module 158.

The valve actuator module 158 may deactivate the cylinder 118 by disabling opening of the intake valve 122 and/or the exhaust valve 130. The valve actuator module 158 may disable opening of the intake valve 122 by decoupling the intake valve 122 from the intake cam phaser 148. Similarly, the valve actuator module 158 may disable opening of the exhaust valve 130 by decoupling the exhaust valve 130 from the exhaust cam phaser 150. In various implementations, the valve actuator module 158 may control the intake valve 122 and/or the exhaust valve 130 using devices other than camshafts, such as electromagnetic or electrohydraulic actuators.

The engine system 100 may include a boost device that provides pressurized air to the intake manifold 110. For example, FIG. 1 shows a turbocharger including a hot turbine 160-1 that is powered by hot exhaust gases flowing through the exhaust system 134. The turbocharger also includes a cold air compressor 160-2, driven by the turbine 160-1, that compresses air leading into the throttle valve 112. In various implementations, a supercharger (not shown), driven by the crankshaft, may compress air from the throttle valve 112 and deliver the compressed air to the intake manifold 110.

A wastegate 162 may allow exhaust to bypass the turbine 160-1, thereby reducing the boost (the amount of intake air compression) of the turbocharger. The ECM 114 may control the turbocharger via a boost actuator module 164. The boost actuator module 164 may modulate the boost of the turbocharger by controlling the position of the wastegate 162. In various implementations, multiple turbochargers may be controlled by the boost actuator module 164. The turbocharger may have variable geometry, which may be controlled by the boost actuator module 164.

An intercooler (not shown) may dissipate some of the heat contained in the compressed air charge, which is generated as the air is compressed. The compressed air charge may also have absorbed heat from components of the exhaust system 134. Although shown separated for purposes of illustration, the turbine 160-1 and the compressor 160-2 may be attached to each other, placing intake air in close proximity to hot exhaust.

The engine system 100 may include an exhaust gas recirculation (EGR) valve 170, which selectively redirects exhaust gas back to the intake manifold 110. The EGR valve 170 may be located upstream of the turbocharger's turbine 160-1. The EGR valve 170 may be controlled by an EGR actuator module 172.

The engine system 100 may measure the position of the crankshaft using a crankshaft position (CKP) sensor 180. The temperature of the engine coolant may be measured using an engine coolant temperature (ECT) sensor 182. The ECT sensor 182 may be located within the engine 102 or at other locations where the coolant is circulated, such as a radiator (not shown).

The pressure within the intake manifold 110 may be measured using a manifold absolute pressure (MAP) sensor 184. In various implementations, engine vacuum, which is the difference between ambient air pressure and the pressure within the intake manifold 110, may be measured. The mass flow rate of air flowing into the intake manifold 110 may be measured using a mass air flow (MAF) sensor 186. In various implementations, the MAF sensor 186 may be located in a housing that also includes the throttle valve 112.

The throttle actuator module 116 may monitor the position of the throttle valve 112 using one or more throttle position sensors (TPS) 190. The ambient temperature of air being drawn into the engine 102 may be measured using an intake air temperature (IAT) sensor 192. The temperature of exhaust gas within the exhaust system 134 may be measured using an exhaust gas temperature (EGT) sensor 193. The ECM 114 may use signals from the sensors to make control decisions for the engine system 100.

The ECM 114 may communicate with a transmission control module (TCM) 194 to coordinate shifting gears in a transmission (not shown). For example, the ECM 114 may reduce engine torque during a gear shift. The ECM 114 may communicate with a hybrid control module (HCM) 196 to coordinate operation of the engine 102 and an electric motor 198. The electric motor 198 may also function as a generator, and may be used to produce electrical energy for use by vehicle electrical systems and/or for storage in a battery. In various implementations, various functions of the ECM 114, the TCM 194, and the HCM 196 may be integrated into one or more modules.

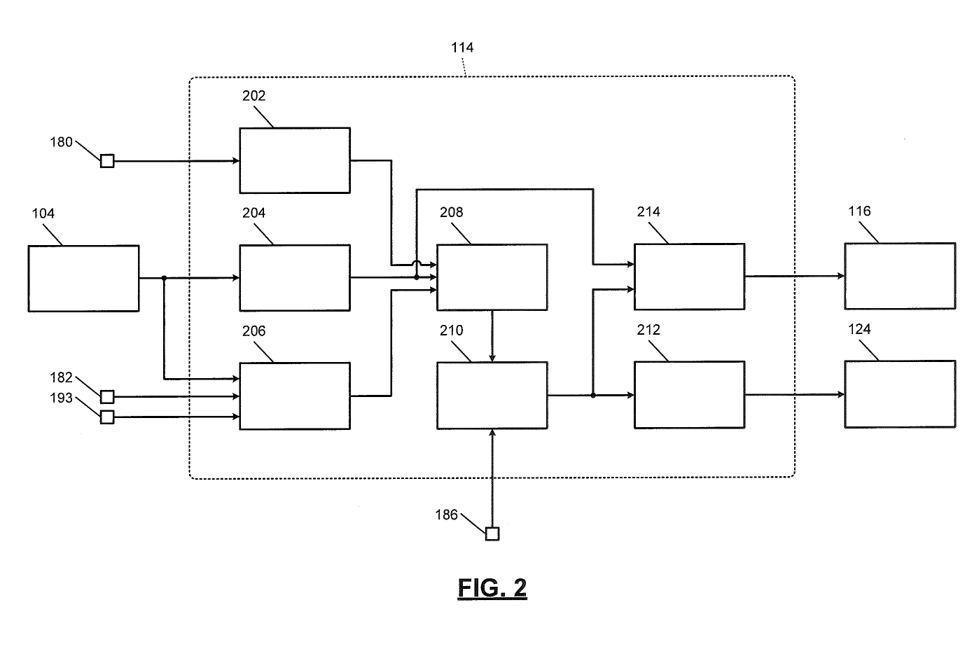

Referring now to FIG. 2, an example implementation of the ECM 114 includes an engine speed module 202, a desired air flow module 204, and a desired air/fuel (NF) ratio module 206. The engine speed module 202 determines engine speed. The engine speed module 202 may determine the engine speed based on the crankshaft position from the CKP sensor 180. For example, the engine speed module 202 may determine the engine speed based on a period of crankshaft rotation corresponding to a number of tooth detections. The engine speed module 202 outputs the engine speed.

The desired air flow module 204 determines a desired amount of air flow to each cylinder of the engine 102, which may be referred to as a desired air per cylinder (APC). The desired air flow module 204 may determine the desired air flow based on torque demand on the engine 102, which may be determined based on a driver input, such as an accelerator pedal position or a cruise control setting, and/or one or more accessory loads. The desired air flow module 204 outputs the desired air flow.

The desired A/F ratio module 206 determines a desired A/F ratio of the engine 102. The desired A/F ratio module 206 may determine the desired A/F ratio based on engine operating conditions. For example, the desired A/F ratio module 206 may adjust the desired A/F ratio to a rich A/F ratio for engine warm-up and/or for exhaust component protection. The desired A/F ratio module 206 may determine whether the engine 102 is warming up and/or whether components of the exhaust system 134 may be damaged due to overheating based on the engine coolant temperature, the exhaust gas temperature and/or an engine operating period. The desired A/F ratio module 206 may determine the engine operating period based on a driver input such as when an ignition is switched on. The desired A/F ratio module 206 outputs the desired A/F ratio.

A desired injection duration module 208 determines a desired duration of fuel injection for each cylinder of the engine 102. The desired injection duration module 208 may determine the desired injection duration based on the engine speed, the desired air flow, and the desired A/F ratio. For example, the desired injection duration module 208 may adjust the desired injection duration to achieve the desired A/F ratio at the desired air flow and the engine speed. The desired injection duration module 208 outputs the desired injection duration.

An injection duration limit module 210 determines an injection duration limit (e.g., a maximum injection duration). The injection duration limit module 210 may determine the injection duration limit based on the engine speed, engine load, and/or fuel injector characteristics. The injection duration limit module 210 may determine the engine load based on the mass flow rate of air measured by the MAF sensor 186. The fuel injector characteristics may include static flow rate, orifice size, and/or plunger size. The injection duration limit module 210 may determine the injection duration limit based on a relationship between the engine speed, the engine load, and the injection duration limit. The relationship may be predetermined based on the fuel injector characteristics.

The injection duration limit module 210 compares the desired injection duration to the injection duration limit and limits the desired injection duration to the injection duration limit if the desired injection duration is greater than the injection duration limit. If the desired injection duration is less than or equal to the injection duration limit, the injection duration limit module 210 does not limit the desired injection duration. The injection duration limit module 210 outputs a signal indicating the desired injection duration and whether the desired injection duration is limited.

A fuel control module 212 controls the timing and duration of fuel injection in the engine 102. The fuel control module 212 may control the injection timing and duration by outputting a start of injection, an injection duration, and/or an end of injection. The start and end of injection may be specified as a crank angle relative to TDC. The fuel actuator module 124 may open and close the fuel injector 125 based on the start of injection, the injection duration, and/or the end of injection.

The fuel control module 212 may adjust the start of injection to improve combustion stability and/or to reduce particulate emission levels. The fuel control module 212 may adjust the end of injection based on the start of injection and the desired injection duration. In various implementations, the injection duration limit module 210 may output the injection duration limit instead of the desired injection duration when the desired injection duration is greater than the injection duration limit. In these implementations, the fuel control module 212 may adjust the end of injection based on the injection duration limit instead of the desired injection duration.

A throttle control module 214 controls the amount of air flow through the engine 102. The throttle control module 214 may control the air flow by outputting a desired throttle area. The throttle actuator module 116 may regulate the throttle valve 112 based on the desired throttle area. The throttle control module 214 may receive the desired air flow from the desired air flow module 204. If the injection duration limit module 210 limits the desired injection duration, the fuel control module 212 may determine a desired fuel flow based on the desired injection duration as limited, engine operating conditions, and/or fuel injector characteristics. In addition, the throttle control module 214 may limit the desired air flow based on the desired fuel flow and the desired NF ratio and adjust the desired throttle area to achieve the desired air flow as limited.

The engine operating conditions used to determine the desired fuel flow may include the pressure of fuel supplied to the fuel injector 125, the current APC, and/or the engine speed. If the engine 102 is a port fuel injected engine, the fuel pressure may be relatively constant (e.g., a value from 300 kilopascals (kPa) to 600 kPa). Thus, the fuel pressure may be predetermined. If the engine 102 is a spark ignition direct injection engine the fuel pressure may be within a relatively broad range (e.g., a range from 1 megapascal (MPa) to 30 MPa). Thus, the fuel pressure may be measured.

Referring again to FIG. 2, the fuel injector characteristics used to determine the desired fuel may include a rise time, a time from peak to hold, and a time at hold. The rise time is a period from a first time when the fuel injector 125 is opened to a second time when fuel flow through the fuel injector 125 is equal to a peak value. The time from peak to hold is a period from the second time to a third time when fuel flow through the fuel injector 125 is equal to and held at a static value (e.g., when changes in fuel flow through the fuel injector are less than a predetermined value). The time at hold is a period from the third time to a fourth time when the injector is closed.

If the injection duration limit module 210 does not limit the desired injection duration, the throttle control module 214 may not limit the desired air flow based on the desired fuel flow. In addition, the throttle control module 214 may adjust the desired throttle area to achieve the desired air flow as determined by the desired air flow module 204. The throttle control module 214 may determine whether the injection duration limit module 210 limits the desired injection duration based on the signal output by the injection duration limit module 210.

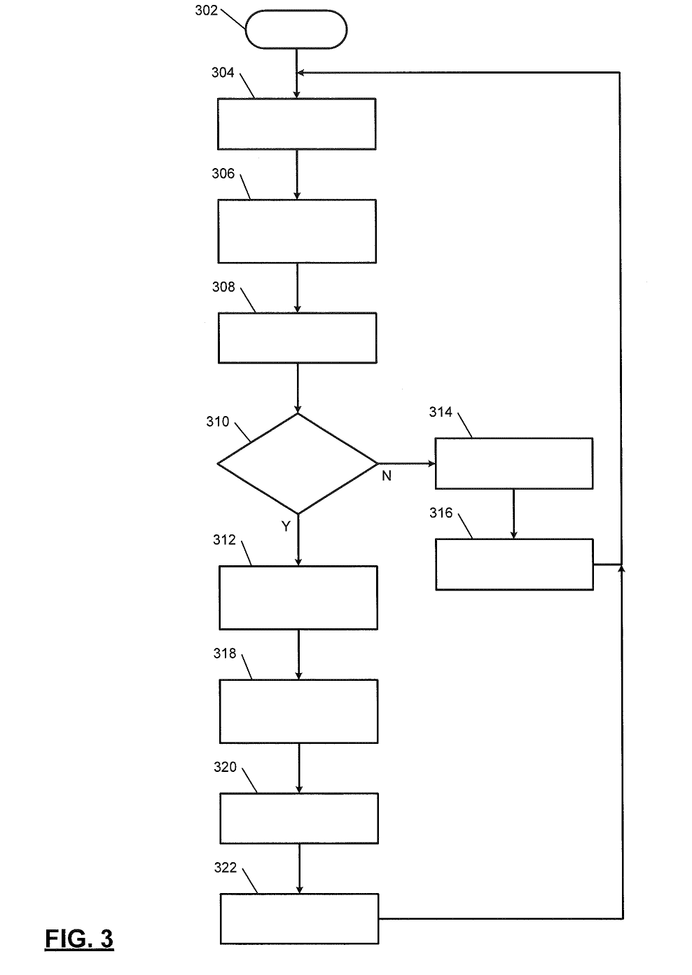

Referring now to FIG. 3, a method for controlling the amount of air flow to each cylinder of an engine based on an injection duration limit begins at 302. At 304, the method determines a desired APC. The method may determine the desired APC based on torque demand on the engine. The method may determine the torque demand based on a driver input, such as an accelerator pedal position or a cruise control setting, and/or one or more accessory loads.

At 306, the method determines a desired injection duration. The method may determine the desired injection duration based on engine speed, the desired APC, and a desired NF ratio. For example, the method may adjust the desired injection duration to achieve the desired NF ratio at the desired APC and the engine speed.

At 308, the method determines the injection duration limit. The method may determine the injection duration limit based on engine speed, engine load, and/or fuel injector characteristics. The method may determine the engine load based on intake air flow. The fuel injector characteristics may include static flow rate, orifice size, and/or plunger size. The method may determine the injection duration limit based on a relationship between the engine speed, the engine load, and the injection duration limit. The relationship may be predetermined based on the fuel injector characteristics.

At 310, the method determines whether the desired injection duration is greater than an injection duration limit. If the desired injection duration is greater than the injection duration limit, the method continues at 312. Otherwise, the method continues at 314. At 314, the method controls a throttle of the engine based on the desired APC. At 316, the method controls a fuel injector of the engine based on the desired injection duration.

At 312, the method determines a fuel flow limit based on the injection duration limit, engine operating conditions, and characteristics of the fuel injector. The engine operating conditions may include fuel pressure, current APC, and/or engine speed. The fuel injector characteristics may include rise time, time from peak to hold, and time at hold. These fuel injector characteristics are discussed above with reference to FIG. 2.

At 318, the method determines an APC limit based on the fuel flow limit and the desired air/fuel ratio. The APC limit may be referred to as an air flow limit. At 320, the method controls the throttle based on the APC limit. At 322, the method controls the fuel injector based on the injection duration limit. The method may adjust a start of injection to improve combustion stability and/or reduce particulate emission levels, and adjust an end of injection based on the start of injection and the injection duration limit.

The method may generate a signal indicating whether the desired injection duration is limited. The signal may indicate that the desired injection duration is limited when the method controls the fuel injector based on the injection duration limit. Otherwise, the signal may indicate that the desired injection duration is not limited.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A system comprising:
a desired injection duration module that determines a desired injection duration;
a fuel control module that:
compares the desired injection duration to an injection duration limit; and
controls a fuel injector of an engine based on the injection duration limit when the desired injection duration is greater than the injection duration limit; and
a throttle control module that controls a throttle of the engine based on the injection duration limit when the desired injection duration is greater than the injection duration limit.

2. The system of claim 1 wherein, when the desired injection duration is greater than the injection duration limit, the fuel control module determines a fuel flow limit based on the injection duration limit.

3. The system of claim 2 wherein, when the desired injection duration is greater than the injection duration limit, the throttle control module:
determines an air flow limit based on the fuel flow limit and a desired air/fuel ratio; and
controls the throttle based on the air flow limit.

4. The system of claim 2 wherein the fuel control module determines the fuel flow limit based on the injection duration limit, engine operating conditions, and characteristics of the fuel injector.

5. The system of claim 4 wherein the engine operating conditions include fuel pressure, measured air flow, and engine speed.

6. The system of claim 4 wherein the fuel injector characteristics include a first period from a first time when the injector is opened to a second time when fuel flow through the injector is equal to a peak flow.

7. The system of claim 6 wherein the fuel injector characteristics include a second period from the second time to a third time when changes in fuel flow through the fuel injector are less than a predetermined value.

8. The system of claim 7 wherein the fuel injector characteristics include a third period from the third time to a fourth time when the injector is closed.

9. The system of claim 1 wherein the fuel control module:
determines the desired injection duration based on a desired air flow and a desired air/fuel ratio; and
controls the fuel injector based on the desired injection duration when the desired injection duration is less than the injection duration limit.

10. The system of claim 9 further comprising a desired air flow module that determines the desired air flow based on driver input, wherein the throttle control module controls the throttle based on the desired air flow when the desired injection duration is less than the injection duration limit.

11. A method comprising:
determining a desired injection duration;
comparing the desired injection duration to an injection duration limit;
controlling a fuel injector of an engine based on the injection duration limit when the desired injection duration is greater than the injection duration limit; and
controlling a throttle of the engine based on the injection duration limit when the desired injection duration is greater than the injection duration limit.

12. The method of claim 11 further comprising determining a fuel flow limit based on the injection duration limit when the desired injection duration is greater than the injection duration limit.

13. The method of claim 12 further comprising determining an air flow limit based on the fuel flow limit and a desired air/fuel ratio and controlling the throttle based on the air flow limit when the desired injection duration is greater than the injection duration limit.

14. The method of claim 12 further comprising determining the fuel flow limit based on the injection duration limit, engine operating conditions, and characteristics of the fuel injector.

15. The method of claim 14 wherein the engine operating conditions include fuel pressure, measured air flow, and engine speed.

16. The method of claim 14 wherein the fuel injector characteristics include a first period from a first time when the injector is opened to a second time when fuel flow through the injector is equal to a peak flow.

17. The method of claim 16 wherein the fuel injector characteristics include a second period from the second time to a third time when changes in fuel flow through the fuel injector are less than a predetermined value.

18. The method of claim 17 wherein the fuel injector characteristics include a third period from the third time to a fourth time when the injector is closed.

19. The method of claim 11 further comprising:
determining the desired injection duration based on a desired air flow and a desired air/fuel ratio; and
controlling the fuel injector based on the desired injection duration when the desired injection duration is less than the injection duration limit.

20. The method of claim 19 further comprising:
determining the desired air flow based on driver input; and
controlling the throttle based on the desired air flow when the desired injection duration is less than the injection duration limit.
